(19) United States
(12) Patent Application Publication
(10) Pub. No.: US 2014/0083704 A1
(43) Pub. Date: Mar. 27, 2014

(54) METHOD FOR REDUCING CONING IN OIL WELLS BY MEANS OF MICRO (NANO) STRUCTURED FLUIDS WITH CONTROLLED RELEASE OF BARRIER SUBSTANCES

(71) Applicant: ENI S.p.A., Roma (IT)

(72) Inventors: Marco Sangermano, Torino (IT); Francesca Verga, Torino (IT); Laura Montanaro, Torino (IT)

(73) Assignee: ENI S.p.A., Roma (IT)

(21) Appl. No.: 13/976,806

(22) PCT Filed: Dec. 27, 2011
(86) PCT No.: PCT/IB2011/055978

§ 371 Date: Nov. 5, 2013

(30) Foreign Application Priority Data
Dec. 27, 2010 (IT) MI2010A 002413

(51) Int. Cl. C09K 8/588; E21B 43/16

(52) U.S. Cl. CPC C09K 8/588; E21B 43/16
USPC 166/305.1; 507/225; 507/224; 507/212

(57) ABSTRACT

The present invention relates to a method for reducing the coning in an oil well of an underground reservoir delimited by an aquifer which comprises an injection phase of a micro(nano)-structured fluid with controlled release of barrier substances in said aquifer with the formation of an impermeable barrier located at the oil/water interface, characterized in that said fluid comprises an aqueous dispersion of microcapsules composed of a core comprising a modifying substance of the absolute permeability of the rock formation which contains said reservoir, a protective shell insoluble in water which coats said core. The present invention also relates to the above mentioned microcapsules and an aqueous dispersion comprising the above mentioned microcapsules to be used in said method.

The present invention relates to a method for reducing the coning in oil wells by means of micro(nano)structured fluids which provides the controlled release of barrier substances.

In particular, the present invention relates to a method for limiting water coning in oil wells based on the in situ formation of a barrier located at the oil/water interface by injection into the subsoil of the above mentioned fluids.

The present invention also relates to the above mentioned micro(nano)structured fluid with controlled release of barrier substances and microcapsules containing the above mentioned barrier substances.

The formation of water coning is a phenomenon which interests the extraction activity of hydrocarbons (oil or natural gas) from underground reservoirs by means of oil wells.

Water coning is a phenomenon connected to the presence of an aquifer which delimits the reservoir either below or laterally. When the extraction flow-rate of the oil exceeds a certain limit value, due to the depression created by the extraction activity, the water of the aquifer is dragged upwards in the direction of the production well (according to a cone-shaped profile) and is extracted together with the oil. As the production proceeds, the quantity of water extracted together with the oil tends to progressively increase until it prevails over the amount of oil produced.

The production of oil with high quantities of water considerably reduces the extraction efficiency of the oil from the reservoir, it increases the overall production costs (also because it requires the separation of the water from the oil) and, eventually, creates the problem of water disposal under safety conditions for the environment.

Various solutions to the problem of water coning have been proposed in the state of the art.

A first solution is represented by the directional drilling of wells, i.e. the drilling of extraction wells having trajectories and completions specifically studied for reducing coning phenomena.

A second solution is represented by the formation of permeability barriers to water in the immediate proximity of the well by injections into the subsoil of chemical compounds capable of modifying the permeability characteristics of the rock formation, reducing the permeability of water with respect to that of oil. The compounds used for this purpose are generally polymers, gels or foams. These compounds are known as relative permeability modifiers.

An example of the use of this technique is described in the U.S. Pat. No. 3,965,986. This document describes a method for reducing water coning based on the reduction of the permeability to water in selected zones of a reservoir, thus slowing down the migration of water towards the production well. The reduction in the permeability is obtained through a first injection of an aqueous dispersion of colloidal silica, followed by a second injection of water containing a surfactant, with the formation of a gel which reduces the permeability of the porous matrix.

A second example of a method for reducing water coning in an oil reservoir with a high water production is described in the U.S. Pat. No. 5,062,483. The method described provides the injection inside the reservoir of a mass of uncondensable gas (such as air or natural gas) through an injection well located close to the extraction well. This injection increases the gas saturation around the extraction well. In a subsequent phase, the method provides the injection of a further quantity of uncondensable gas through the extraction well and the start of production from the extraction well.

The methods for reducing water coning described in the state of the art and based on the formation of barriers impermeable to water have various disadvantages.

First of all, the known methods only have containment effects in the proximity of the extraction well (within a radius in the order of a few meters of distance from it), thus providing extremely limited benefits in terms of increase in the final oil recovery factor.

Secondly, these methods envisage the injection of chemical compounds inside the rock containing the oil with a high risk of irremediably damaging the production well in the case of mistakes in the injection procedure, as this occurs through the same well.

Furthermore, the injection of chemical compounds into the reservoir according to the known art would not, create, except to a very limited extent, permeability barriers in precise zones of the subsoil, in particular where they would be most necessary or effective.

In consideration of the above mentioned state of the art in the field of the oil industry, the necessity is strongly felt for finding alternative, and possibly more advantageous and effective, methods for opposing the effects of water coning.

An objective of the present invention is to overcome the drawbacks revealed in the state of the art.

An object of the present invention therefore relates to a method for reducing coning in an oil well of an underground reservoir delimited by an aquifer comprising an injection phase of a micro(nano)-structured fluid providing a controlled release of barrier substances in said aquifer with the formation of an impermeable barrier located at the oil/water interface, characterized in that said fluid comprises an aqueous dispersion of microcapsules composed of
a core comprising a modifying substance of the absolute permeability of the rock formation which contains said reservoir,
a protective shell insoluble in water which coats said core.

A second object of the present invention relates to a microcapsule consisting of
a core comprising a modifying substance of the absolute permeability of the rock formation of an oil reservoir,
a protective shell insoluble in water which coats said core.

Further objects of the present invention relate to a micro(nano)structured fluid comprising an aqueous dispersion of the above mentioned microcapsules and to the use thereof in the above mentioned method for reducing coning in oil wells.

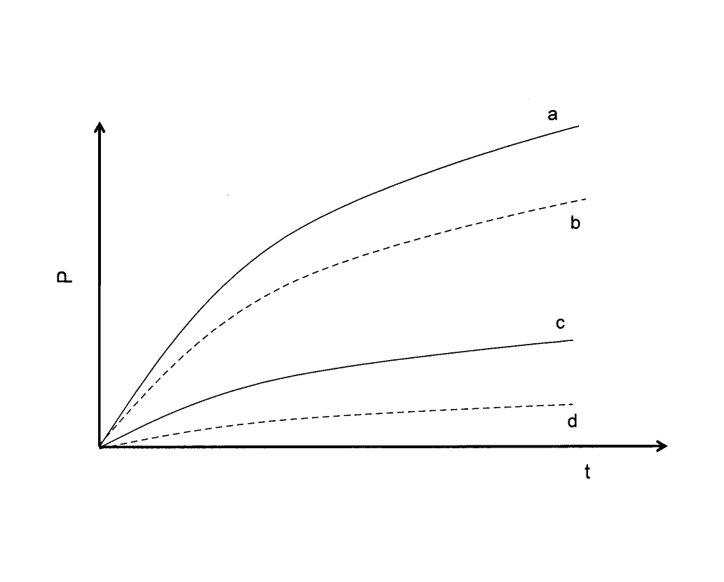

For a better understanding of the characteristics of the present invention, reference will be made to the enclosed FIG. 1, which indicates the cumulative oil production curves (P) from a well versus the duration of the production, simulated by the application of a mathematical model.

The method, object of the present invention, allows an increase in the productivity of a production well and also in the recovery efficiency of hydrocarbon fluids, both liquid (oil) and gaseous (natural gas), from the reservoir, preventing the occurrence or considerably reducing the creation of water coning phenomena.

In the following description, reference will be made to the application of the method of the present invention to the extraction of oil from an underground reservoir. The present invention can also be applied, however, with the same advantages, to the case of a natural gas reservoir.

An object of the present invention therefore also relates to the method previously described for reducing coning in a natural gas production well.

The method is based on the in situ formation of a permeability barrier located at the interface between the hydrocarbon fluid and water. The barrier prevents or at least slows down the movement of the water present in the reservoir towards the production well, delaying or preventing the occurrence of water coning.

The permeability barrier that can be obtained with the method of the present invention can have a considerable extension, as far as occupying an area which extends for a radius of various tens of meters from the production well. Thanks to this extension, the barrier attenuates undesired effects of coning much more effectively than the methods of the known art. In the most favourable cases, the efficacy of the barrier can be such as to completely prevent the occurrence of coning phenomena.

The method, object of the present invention, also has the advantage of being applicable either before starting the exploitation of the reservoir, i.e. before “starting the production” of the extraction well, or after the exploitation has already been started.

According to the present invention, the permeability barrier is obtained in situ by the injection into the aquifer of an aqueous dispersion containing microcapsules providing the controlled release of barrier substances, i.e. substances which can modify the absolute permeability of a reservoir by forming, in situ, a barrier to water flowing towards the production wells.

Examples of barriers that can be formed using permeability modifying substances are barriers made of inorganic gels and organic gels (also called polymer gels). Among barriers made of inorganic gels, those obtained by the gelation of barrier substances such as metal-alkoxide compounds, in particular alkoxy-silanes (Si-alkoxides), are particularly effective.

Among the barriers made of organic gel, those in polyacrylamide gel, obtained by the copolymerization of barrier substances such as acrylamide and N,N′-methylene-bis-acrylamide, and those made of starch-based gels, obtained by the gelation of starch (barrier substance) in water, are particularly preferred.

The micro(nano)structured fluid providing controlled release of barrier substances, object of the present invention, consists of an aqueous dispersion of microcapsules containing a permeability modifying substance.

Once they have been injected into the subsoil, the microcapsules contained in the fluid migrate in the aquifer towards the water/oil interface of the reservoir, where they can release the contents of their core. Therefore, the barrier substance, released according to various possible physical or chemical mechanisms, produces in situ substances capable of modifying the permeability characteristics of the rock formation (permeability modifiers) thanks to the clogging of the porous intergranular spaces.

The microcapsules consist of a core, containing the barrier substance, and a coating shell made of a material substantially insoluble in water. The coating shell covers the whole surface of the core.

The microcapsules substantially have a spherical shape and a diameter within the range of 0.01-30 μm.

The material forming the coating shell has chemical and physical characteristics which are such as to protect the contents of the core while the microcapsules are in aqueous dispersion and during their injection into the aquifer. As a result of this protection, the microcapsules can pass through the aquifer unaltered as far as until the oil/water interface, where they release the barrier substance contained in the core and form an impermeable barrier in situ.

The modes and release time of the contents of the core at the oil/water interface can be controlled by suitably selecting the material composing the shell of the microcapsules with respect to the characteristics of the reservoir. The release time also depends on the thickness of the protective shell and the temperature at which the microcapsules are exposed.

In a first preferred embodiment of the present invention, the contents of the core are released in a controlled way by dissolution of the protective shell of the microcapsules when in contact with the oil phase at the oil/water interface. For this purpose, the shell is made of an oil-soluble material.

In a second preferred embodiment, the contents of the core are released in a controlled way by the thermal decomposition of the protective shell of the microcapsules close to the oil/water interface. For this purpose, the shell is made of a thermally degradable material under the specific temperature conditions of the reservoir.

In a third preferred embodiment, the contents of the core are released in a controlled way close to the oil/water interface by diffusion through the protective shell. For this purpose, the shell is made of a material permeable to the barrier substance contained in the core; once the microcapsule has reached the oil/water interface, the barrier substance diffuses through the shell at a controlled rate.

By suitably varying the chemical composition of the shell, it is therefore possible to accurately control both the release point of the barrier substances inside the reservoir and also the formation rate of the barrier itself. The formation rate of the barrier also depends on the type of the chemical or physical phenomenon which leads to the formation of the barrier (polymerization, swelling).

In order to enable the microcapsules to reach the oil/water interface unaltered, the material of which the shell of the microcapsules is composed must be insoluble in water. Insoluble material means a material having a sufficiently low dissolution rate in water (under the specific temperature and pressure conditions of the aquifer) as to guarantee that the microcapsules can reach the oil/water interface almost unaltered.

The material of which the shell is composed can be selected from a wide range of polymeric materials known in the state of the art. Examples of polymeric materials are: polyethyleneglycol, polyacrylate, polymethacrylate, polystyrene, cellulose, polylactate, poly(lactic-co-glycol) copolymer.

The use of mono- and multi-functional acrylic resins polymerizable by means of UV radiations, is particularly preferred. Monofunctional acrylic resins are resins based on mono-unsaturated acrylic monomers, such as, for example, esters and amides of acrylic and methacrylic acid, particularly methylmethacrylate. Multifunctional acrylic resins according to the present invention are cross-linkable resins comprising multifunctional acrylic monomers such as polyunsaturated acrylic compounds such as ethyleneglycole dimethacrylate, or vinyl methacrylate. According to what is generally known in the art, multifunctional acrylic resins comprise a mixture of both monofunctional and multifunctional acrylic monomers.

The use of monofunctional acrylic resins allows thermoplastic coating shells, insoluble in water and soluble in the oil phase, to be obtained. The contents of the core of these microcapsules is released at the oil/water interface by dissolution of the shell following contact with the oil.

By using multifunctional acrylic resins, on the other hand, rigid shells are obtained, which are insoluble in both water and oil, due to the high crosslinking degree which can be obtained with the polymerization of these resins. In this case, the contents of the core are released at the oil/water interface by diffusion through the polymeric material of the shell. The diffusion rate can be controlled by varying the thickness of the shell. The diffusion rate also depends on the diffusion coefficient of the core material through the shell material.

The choice of absolute permeability modifying substance varies depending on the type of barrier to be obtained.

In order to form an impermeable barrier consisting of an inorganic gel, for example, the core can consist of a compound belonging to the group of organometallic compounds, in particular metal-alkoxides, wherein the metal, for example, is Si, Al, Ti and Zr. The metal-alkoxide compound is preferably an alkoxy-silane, more preferably a compound selected from the group consisting of tetramethylorthosilane (TMOS), tetraethylorthosilane (TEOS), trimethylmethoxysilane (TMMS), methyltrimethoxysilane (MTMS) and methyltriethoxysilane (MTES).

A particularly preferred alkoxy-silane compound is TMOS, which is insoluble in water and slightly soluble in oil.

The above-mentioned metal-alkoxide compounds, when in contact with the water present at the oil/water interface, are transformed into a gel according to the reaction mechanism known as the “sol-gel” process. The inorganic gel formed modifies the permeability of the rock formation, thus reducing the coning phenomenon.

The properties of inorganic gels (for example, the stiffness) and the rate of their formation process (gelation) depend on various parameters such as the nature of the barrier substance, temperature of the gelification process, the water salinity, the pH value.

In order to control and/or favour the gelation process, the core can also contain catalysts or other additives typically used in gelling systems and known in the art, such as surfactants, stabilizers, antifoaming agents and pH buffers.

In order to obtain an impermeable barrier consisting of an organic polymeric gel, a monomer and/or pre-polymer must react at the oil/water interface with a crosslinking agent.

For this purpose, the method, object of the present invention, envisages the injection, into the aquifer, of an aqueous dispersion comprising microcapsules having a core consisting of one or more monomers and/or pre-polymers (monomer-microcapsules) and microcapsules having a core consisting of a crosslinking agent (crosslinking-microcapsules).

The monomer-microcapsules and crosslinking-microcapsules can be injected into the aquifer contemporaneously in the same aqueous dispersion.

Alternatively, the injection phase can envisage a first injection of a first dispersion comprising the monomer-microcapsules and a second injection of a second dispersion comprising the crosslinking-microcapsules. The two aqueous dispersions can be injected into the aquifer in any order.

Monomers and/or pre-polymers suitable for the purposes of the present invention are, for example, acrylamide, N,N′-methylene-bis-acrylamide and partially hydrolyzed polyacrylamide.

The crosslinking agents (also called polymerization initiators) generally consist of metallic compounds, in particular Cr or Al compounds, organic compounds, for example aldehydes (glutaraldehyde, formaldehyde), phenol, o-aminobenzoic acid, m-aminophenol, phenylacetate and furfuryl alcohol.

Once the monomer-microcapsules and crosslinking-microcapsules have reached the water/oil interface, each of them releases the constituent of the core initiating the polymerization, which forms the polymeric gel, acting as an impermeable barrier, particularly effective for limiting or blocking the flow of water towards the production wells.

In a preferred embodiment of the present invention, the in situ formation of a barrier of polymeric gel is obtained by driving to the oil/water interface:
monomer-microcapsules having a core of acrylamide monomer,
monomer-microcapsules having a core of N,N′-methylene-bis-acrylamide,
crosslinking-microcapsules having a core of ammonium persulfate and tetramethylethylenediamine (TEMED). The ammonium persulfate and TEMED act as polymerization initiators.

The abovementioned microcapsules have a coating shell soluble in oil, preferably a coating shell made of polyacrylate.

Once the core of each of the above types of microcapsules is released at the oil/water interface, the polymerization reaction starts, leading to the formation of a polyacrylamide gel.

In a further preferred embodiment of the present invention, the core of the microcapsules consists of starch. The term “starch” means a polysaccharide consisting of a glucose unit bound to another unit by means of α(1-4)-glycoside bonds, characteristic of amylose, and α(1-6)-glycoside bonds, characteristic of amylopectin.

Starch is insoluble in water at room temperature, whereas it gelifies within a temperature range of 60-80° C. Upon contact with the water phase at the water/oil interface, the starch loses its original crystalline structure and the water molecules bind themselves by hydrogen bonds to the exposed hydroxyl groups of the amylase and amylopectin units, causing a swelling of the granules. As starch is a polymer of a natural origin, its use in the method of the present invention as barrier substance has the particular advantage of not releasing substances potentially dangerous for the environment into the subsoil.

The microcapsules having a core comprising starch are preferably covered by a protective shell made of a material soluble in oil, more preferably a shell made of polyacrylate.

In a further preferred embodiment, the microcapsules have a TMOS core covered with an oil-soluble polymeric shell, preferably a shell made of polyacrylate.

The microcapsules are prepared according to encapsulation processes known in the state of the art. The encapsulation technique is used in the state of the art for the preparation of micro- or nano-capsules for the controlled release of active principles for applications in the pharmaceutical, cosmetic, agrochemical field or in the industry of coating compositions (paints, inks, etc.).

For the preparation of the microcapsules of the present invention, the encapsulation of the barrier substances can require a preparation phase of oil-in-water micro- or nano-emulsions or water-in-oil-in-water micro- or nano-emulsions containing the barrier substances and/or compounds necessary for the formation of the shell of the microcapsules, followed by a separation phase of the microcapsules from the respective emulsions.

In the case of precursors insoluble in water, such as starch, for example, the microcapsules can be obtained by emulsion polymerization starting from a dispersion of starch in the monomer (organic phase) of the material which will form the shell. This dispersion is added to an aqueous phase which can contain emulsion stabilizers, for example amphiphilic surfactants, such as polyhydroxybutyrate, polyoxyethylene dodecyl ether, sodium dodecylsulfate and poloxamers, such as poly(ethylene oxide-b-propylene oxide) copolymer (known with the trade-name of Pluronic®).

The organic phase can consist of the monomer alone or a solution of the monomer in suitable organic solvents.

The mixing is carried out by adding the organic phase to the aqueous phase, kept under constant stirring. An oil-in-water emulsion is obtained from mixing, consisting of tiny drops of organic phase dispersed in the aqueous phase. The concentration and size of the drops can be controlled by varying the composition and concentration of the components of the emulsion.

After emulsion polymerization, the drops are then separated from the aqueous phase in the form of microcapsules by centrifugation and then washed with water and dried, for example by means of freeze-drying treatment. The separation of the microcapsules from the emulsion can also be obtained by sedimentation.

At the end of drying, the microcapsules can be used for the preparation of the fluid (aqueous dispersion) to be injected into the subsoil.

In the case of water-soluble precursors, for example acrylamide and N,N′-methylene-bis-acrylamide, the encapsulation can be obtained by preparing a water-in-oil-in-water emulsion of each of the above compounds.

The water-in-oil-in-water emulsion can be prepared by dripping an aqueous solution of the barrier substances into a continuous organic phase, kept under stirring, containing emulsion-stabilizer compounds (for example, of the same type as those described in the case of the encapsulation of water-insoluble precursors).

The water-in-oil emulsion thus obtained is then mixed in turn with a continuous aqueous phase, kept under stirring, containing the precursor of the material of the shell of the microcapsules (for example, butylacrylate or propylacrylate), thus obtaining the water-in-oil-in-water emulsion. After emulsion polymerization, the microcapsules are separated by centrifugation, washed with water and subjected to drying, for example by means of freeze-drying.

The concentration in the aqueous phase or organic phase of the barrier substance forming the core of the microcapsules typically varies within the range of 0.1-50% by weight with respect to the overall weight of the phase.

The concentration in the aqueous phase or organic phase of the substance used for forming the shell of the microcapsules varies within the range of 0.01-25% with respect to the overall weight of the phase.

The concentration of the emulsion stabilizers in the aqueous or organic phase varies within the range of 0.01-1% with respect to the overall weight of the phase.

The microcapsules containing a rigid shell of acrylic resin can be prepared, as previously described, by means of the emulsion polymerization technique, using, in this case, an at least bifunctional acrylic resin.

The barrier substance (for example TMOS) is mixed with a solution in an organic solvent containing an acrylic resin (for example, an epoxy-acrylic resin) and a suitable crosslinking agent (for example, a photo-initiator). Preferred crosslinking agents are pentaerythritol triacrylate (PETA), bis-phenol-A epoxy-diacrylate and tri-propyleneglycol triacrylate.

The solution can also contain an amphiphilic surfactant, for example 3-methacryloyloxy-2-hydroxy-propane-sulfonate.

The emulsion is then exposed to UV radiation. As a result of the UV irradiation, the acrylic resin present around the drops of barrier substance, polymerizes, forming a rigid shell of acrylic polymer.

The encapsulation techniques described above can be applied with equipment known in the state of the art.

The chemical substances which can be used for the preparation of the microcapsules are known in the state of the art and are available on the market.

For the purposes of the present invention, the microcapsules are used for preparing a micro(nano) structured fluid with controlled release of barrier substances to be injected into the subsoil.

The fluid is prepared in the form of an aqueous dispersion of the microcapsules.

The fluid is prepared in concentrated form and diluted with water until an adequate viscosity is obtained for its injection into the aquifer. The viscosity of the fluid is generally comparable to that of water or slightly higher and varies within the range of 0.4-2 cP.

The amount of barrier substance and, therefore, of micro(nano)structured fluid to be injected, varies depending not only on the desired characteristics for the permeability barrier, but also on the other characteristics of the reservoir and aquifer (for example, geometry of the reservoir and aquifer, characteristics of the well through which the injection and the subsequent production of oil occur, permeability of the rock formation, temperature, viscosity of the hydrocarbon fluid, water salinity, etc.).

The injection of the micro(nano)structured fluid into the aquifer is done by using equipment and techniques known in the state of the art in the field of the oil extraction industry.

The injections of the micro(nano)structured fluid can be repeated until the placement and formation of a permeability barrier having the desired dimensions are obtained.

The fluid is generally injected in such an amount that the permeability barrier can extend for a radius varying from a few meters to several tens of meters.

Furthermore, the micro(nano)structured treatment fluid is injected into the subsoil in such an amount that the permeability barrier has a thickness of a few centimeters.

The injection strategy must be specifically verified in relation to the geometrical characteristics of the well-reservoir-aquifer system and petrophysical properties (in particular, permeability) of the rock containing the reservoir and of the aquifer. The injection of the micro(nano)structured fluid, which can last for up to a few weeks, is preferably followed by the injection of water for a period of time in the order of a month. The water injected after the micro(nano)structured fluid has the purpose of pushing the micro(nano)particles away from the injection well, consequently maximizing the extension of the barrier at the oil/water interface for a certain amount of injected barrier substance.

The injection of the fluid is preferably done at increasing flow-rates. This injection strategy, in fact, allows the micro(nano)structured fluid to be more uniformly distributed at the water/oil interface, thus maximizing the extension of the barrier for a certain quantity of barrier substances injected, or else allowing to limit the amount of barrier substances to be injected, to obtain a barrier having the same extension, with respect to operating with more or less constant flow-rates.

The method, object of the present invention, can be applied to reservoirs of hydrocarbon fluids having different geological characteristics. Experimental determinations, although using mathematical models capable of simulating the effects of a permeability barrier obtained with the method, object of the present invention, have revealed that the above method produces the best results when the aquifer has limited thicknesses. In particular, the proposed method provides the best results to be obtained in low-viscosity (equal to or lower than 1 cP) oil reservoirs, or medium-viscosity (several cP) oil reservoirs, with a relatively small thickness of the aquifer (preferably ranging from 2 to 10 m, normally in the order of 5 m), whereas a high rock permeability is not necessary (a permeability in the order of a hundred mD is sufficient).

The permeability barrier may be capable of preventing or in any case reducing the effects of coning phenomena for a limited period of time. With time, as the extraction process proceeds, in fact, the oil/water contact level may rise and the water may flow over the permeability barrier. The time necessary for the occurrence of this phenomenon depends on the geometry of the reservoir and aquifer and also on the strength of the aquifer. By applying the method object of the present invention, however, oil can be produced for more or less lengthy periods (in the order of months) with a reduced or zero production of water, significantly improving the overall extraction efficiency.

Once the effect of positioning a first permeability barrier has vanished, the method can also be applied again, once or several times, to form new permeability barriers. An expert in the field can possibly effect adequate verifications, using known techniques suitable for the purpose, in order to determine sufficiently in advance, the incipient occurrence of new coning phenomena.

The following embodiment examples are provided for purely illustrative purposes of the present invention and should in no way be considered as limiting the protection scope defined by the enclosed claims.

### EXAMPLE 1

Microcapsules having a core containing substances capable of forming, in situ, a barrier of polyacrylamide gel and a polyacrylate shell were prepared as follows.

Three separate solutions in chloroform were prepared, respectively containing 20% by weight of acrylamide, 15% by weight of N,N′-methylene-bis-acrylamide and 2% by weight of ammonium persulfate and TEMED, as radical initiator (the latter percentage refers to the sum of ammonium persulfate and TEMED).

Each organic solution was then dripped into an aqueous solution, kept under constant stirring, containing 10% by weight of butylacrylate, 0.5% by weight of sodium dodecylsulfate as amphiphilic surfactant and 1% by weight of radical photo-initiator of the benzoin type.

Each of the emulsions thus obtained was subjected to emulsion polymerization by irradiation with a UV lamp in an inert atmosphere.

The microcapsules obtained at the end of the polymerization were centrifuged to separate them from the liquid. After being washed with water, the microcapsules were then dried by means of freeze-drying at a pressure lower than 0.1 mbar and a temperature close to −50° C.

### EXAMPLE 2

Microcapsules having a core containing starch and a polyacrylate shell were prepared following the procedure described in Example 1.

The organic phase consists of a suspension containing 30% by weight of starch in a solution of ethanol containing 15% by weight of butylacrylate, 0.5% by weight of sodium dodecylsulfate as amphiphilic surfactant and 1% by weight of radical photo-initiator of the benzoin type.

The organic phase was dripped, under stirring, into an aqueous solution containing 0.5% by weight of sodium dodecylsulfate as amphiphilic surfactant (aqueous phase).

The emulsion was then irradiated with an ultraviolet source in an inert atmosphere until complete polymerization of the shell of the microcapsules.

The microcapsules obtained at the end of the polymerization were centrifuged to separate them from the liquid. After washing with water, the microcapsules were then dried in an oven at 40° C.

### EXAMPLE 3

Microcapsules having a core containing tetramethylorthosilane (TMOS) and a shell of acrylic polymer were prepared with the following emulsion polymerization procedure.

An emulsion in dodecane was prepared, containing:

15% by weight of TMOS;

15% by weight of epoxy-acrylic resin;

0.5% by weight of 3-methacryloyloxy-2-hydroxy-propane-sulfonate;

1% by weight of radical photo-initiator of the benzoin type

(percentages referring to the overall weight of the emulsion).

The emulsion was then subjected to UV radiation until complete polymerization of the shell of the microcapsules. The microcapsules were separated by centrifugation, washed and dried by means of freeze-drying at a pressure lower than 0.1 mbar and a temperature close to −50° C.

### EXAMPLE 4

The in situ formation and the effectiveness of an absolute permeability barrier positioned at the oil/water interface of a hypothetical oil reservoir subject to water coning were simulated by means of a mathematical model.

The variation due to the barrier, in the recovery factor (RF) of two types of oil (a medium oil and a light oil) with respect to the case in which the barrier was absent, was estimated by means of the simulation program called “ECLIPSE Black Oil” (produced by Schlumberger).

The recovery factor RF is the ratio between the quantity of oil that is estimated to be produced and the quantity of oil originally present in the reservoir.

A reservoir located at a depth of 2,000 m, with an initial pressure of 207 bar (3,000 psi) and a temperature of 70° C., was simulated with a mathematical model having radial geometry. Furthermore, a constant oil column of 5 m was considered, whereas the thickness of the aquifer was assumed within the range of 2-26 m.

The 3D dynamic model used for the calculations consisted of 50 cells in the radial direction and 2 cells in direction θ. The vertical dimension was variable depending on the thickness of the aquifer.

For the simulation of the effects of the barrier on the RF parameter, the degree of the reduction in the absolute permeability of the reservoir was correlated with the concentration of the barrier substance, establishing a limit concentration of the barrier substance and a limit oil saturation value.

The following petrophysical characteristics of the reservoir were assumed for the simulation:
porosity of the reservoir equal to 20%,
rock compressibility equal to 4·10⁶ psi⁻¹.

The absolute permeability of the rock formation was varied in the simulations, assuming the following horizontal absolute permeability values: 50 mD, 100 mD, 200 mD and 500 mD. Total isotropic conditions were assumed, as these represent the most critical situation for water coning formation.

The parameters characterizing the reservoir oil are indicated in Table 1.

TABLE 1

| | Medium oil | Light oil |
|---|---|---|
| Density (API) | 30° | 45° |
| Viscosity (cP) | 2 | 0.5 |
| under reservoir | | |
| conditions | | |

For the aquifer, a water density equal to a 1,000 kg/m³, a formation volumetric factor of 1.03 bblᵣ/bbl_{ST} (1 bbl=158.987 l) and a water viscosity value equal to 0.5 cP, were assumed.

For the simulation of the injection of the fluid containing the microcapsules, the “Polymers” option of the calculation program was used, which enables the simulation of a polymeric fluid in aqueous phase. The viscosity of the fluid was considered equal, double or quadruple with respect to that of the water. The density of the polymer was assumed as being equal to 1,000 kg/m³.

The formation process of the barrier after release of the contents of the microcapsules at the water/oil interface was simulated by updating the values of the reservoir parameters in each cell according to the variation in the concentration of the barrier substance calculated by the program. The update of the values of the reservoir parameters was obtained by means of an automatic processing of the output data of the ECLIPSE program, using a second processing program, developed on purpose. This second program verifies when the concentration value calculated in each cell exceeds the established limit value; when this condition is met, the second program calculates a new absolute permeability value for the cell by multiplying the permeability value by a reduction factor which depends on the relation established between limit and actual concentrations of the polymer and the oil saturation.

The calculation of the simulation program was continued until a continuative production of oil from the extraction well was simulated for one year.

By using the calculation model described above, it was possible to evaluate the effectiveness of a permeability barrier in terms of increase in the recovery factor and reduction in water production with respect to the reference scenario (absence of the barrier) for various combinations of thickness of the aquifer, absolute permeability, duration of the injection and oil viscosity.

The results of the simulation by means of the mathematical model show that the in situ formation of a permeability barrier at the oil/water interface allows an increase in the recovery factor (RF) in each hypothetical scenario. The efficacy of the present invention can be observed in FIG. 1, which provides the cumulative oil production curves (P) as a function of the duration of the simulated production (t).

In FIG. 1, the curves with a continuous line “a” and “c” refer to the simulations of oil production in the presence of a permeability barrier at the interface, which led to the lower (worst case) and higher (best case), respectively, in terms of increase in the recovery factor. The dashed lines “b” and “d”, on the other hand, represent the curves of the reference simulations (oil productions without the barrier) corresponding to the curves “a” and “c”, respectively. The results of the simulations of the two cases are summarized in Table 2.

TABLE 2

| | | Thickness | | | |
|---|---|---|---|---|---|
| | Absolute | of | | Barrier | Amount of |
| | permeability | aquifer | ΔRF⁽¹⁾ | radius | polymer |
| Case | (mD) | (m) | (%) | (m) | (lbs⁽²⁾) |
| best | 50 | 4 | 223 | 41 | 7,000 |
| worst | 500 | 26 | 32 | 41 | 57,000 |

⁽¹⁾After a year of simulation.
⁽²⁾1 lb = 0.453592 kg.

The data of Table 2 show that also under less favourable conditions (worst case) the permeability barrier at the interface is effective in slowing down the production of water due to water coning. Furthermore, the oil recovery factor, under suitable conditions (best case), significantly increases within a very short period of time (1 year).

The results of the simulation show that the method, object of the present invention, can be effectively applied to reservoirs with even extremely different petrophysical characteristics and oil properties.

1. A method for reducing coning in an oil well of an underground reservoir delimited by an aquifer, comprising:
(i) injecting a micro- or nano-structured fluid with controlled release of barrier substances in the aquifer so that an impermeable barrier is obtained at an oil/water interface,
wherein the fluid comprises an aqueous dispersion of microcapsules comprising:
a core comprising a modifying substance of absolute permeability of rock formation of the reservoir, and
a protective shell which is insoluble in water and coats the core.

2. The method according to claim 1, wherein the releases the modifying substance in a controlled way by dissolution of the protective shell which is put in contact with an oil phase of the oil/water interface.

3. The method according to claim 1, wherein the core releases the modifying substance in a controlled way by thermal decomposition of the protective shell close to the oil/water interface.

4. The method according to claim 1, wherein the core releases the modifying substance in a controlled way by diffusion through the protective shell.

5. The method according to claim 1, further comprising:
(ii) injecting water in the aquifer after said injecting (i).

6. The method according to claim 1, wherein the aqueous dispersion of microcapsules comprises:
microcapsules which comprise a core comprising a monomer, a pre-polymer, or both, and
microcapsules which comprises a core comprising a cross-linking agent.

7. The method according to claim 1, wherein said injecting (i) comprises
(a) injecting a first aqueous dispersion comprising microcapsules which comprises a core comprising a monomer, a pre-polymer, or both, and
(b) injecting a second aqueous dispersion comprising microcapsules which comprises a core comprising a cross-linking agent.

8. A microcapsule, comprising:
a core comprising a modifying substance of absolute permeability of rock formation of an oil reservoir, and
a protective shell which is insoluble in water and coats the core.

9. The microcapsule according to claim 8, wherein the modifying substance is an alkoxide compound, and
the alkoxide compound comprises an element selected from the group consisting of Si, Al, Ti and Zr.

10. The microcapsule according to claim 8, wherein the modifying substance is an alkoxy-silane selected from the group consisting of tetramethylorthosilane (TMOS), tetraethylorthosilane (TEOS), trimethylmethoxysilane (TMMS), methyltrimethoxysilane (MTMS) and methyltriethoxysilane (MTES).

11. The microcapsule according to claim 8, wherein the core comprises:
a monomer, a pre-polymer, or both, or
a cross-linking agent.

12. The microcapsule according to claim 11, wherein the monomer or the pre-polymer is selected from the group consisting of acrylamide, N,N′-methylene-bis-acrylamide, and a partially hydrolyzed polyacrylamide.

13. The microcapsule according to claim 11, wherein the cross-linking agent is selected from the group consisting of a Cr or Al compound, glutaraldehyde, formaldehyde, phenol, o-aminobenzoic acid, m-aminophenol, phenylacetat; and furfuryl alcohol.

14. The microcapsule according to claim 8, wherein the protective shell comprises a polymer selected from the group consisting of polyethyleneglycol, polyacrylate, polymethacrylate, polystyrene, cellulose, polylactate, and poly(lactic-co-glycol) copolymer.

15. The microcapsule according to claim 8, wherein
the core comprises starch; and
the protective shell comprises polyacrylate.

16. The microcapsule according to claim 8, wherein
the core comprises tetramethylorthosilane; and
the protective shell consists of an acrylic polymer of a mono- or multi-functional acrylic resin.

17. A micro- or nano-structured fluid, comprising an aqueous dispersion of the microcapsule according to claim 8.

18. (canceled)
